(19) United States
(12) Patent Application Publication
(10) Pub. No.: US 2022/0159971 A1
(43) Pub. Date: May 26, 2022

(54) Plant and Soil Amendment Composition and Method

(71) Applicant: HI-AG GROUP, LTD., Mabank, TX (US)

(72) Inventor: Frank Bonner, Mabank, TX (US)

(21) Appl. No.: 17/434,856

(22) PCT Filed: Mar. 1, 2019
(86) PCT No.: PCT/US2019/020233

§ 371 Date: Aug. 30, 2021

(51) Int. Cl. A01N 65/26; A01N 65/42; C09K 17/14

(52) U.S. Cl. CPC A01N 65/26; C09K 17/14; A01N 65/42

(57) ABSTRACT

A soil and/or plant amendment composition is formed from a base composition having from 10 wt % to 99.9 wt % aloe vera by total weight of the base composition. The base composition further includes from 0.01 wt % to 25 wt % neem by total weight of the base composition and from 0.01 wt % to 25 wt % turmeric by total weight of the base composition. The base composition may also contain a giant kelp or dulse component. The base composition is mixed with water to form a treatment solution that can then be applied to plants or soil to facilitate plant growth.

### FIELD OF THE INVENTION

The invention relates to plant and soil amendment compositions and methods of treating plants and soils to facilitate plant growth.

### BACKGROUND

Chemicals, fertilizers and pesticides are commonly used to increase crop and plant production. With respect to pesticides, their use may be beneficial in the growing and production of plants and crops. As a result of their long term use, however, pests and damaging organisms have become resistant to them so that more chemicals or different, more potent chemicals are needed to control them. In some instances, the plants or crops must be genetically modified to accommodate the higher amounts or the different chemicals used so that they do not kill or damage the plants themselves.

The resistance to chemicals is true for both insects and damaging fungi or other organisms that are harmful to plants. Fungi and other organisms have the same issues. For example, chemicals that have been used kill damaging fungi, such as Downey mildew, are not as effective as they have been in the past, thus causing growers to use more chemicals or different chemicals to prevent the fungi from killing the plants or crops. As an example, where only a few ounces of a chemical or pesticide may have been effective in years past to treat certain plants or crops, it may now take a gallon or more of the same chemical or pesticide to achieve the same result.

The use of more or more potent pesticides and chemicals may increase production costs due to the increased amount or higher cost chemicals used.

Additionally, where genetically modified plants or crops must be used to withstand the use of increased amounts of chemicals or the more potent chemicals, higher costs may be associated with such genetically enhanced plants.

Another issue with the use of chemicals in plant or crop production is related to health concerns. Because more chemicals are being used, the plants or crops themselves may have a higher content of such chemicals. While smaller quantities of chemicals may not raise such health concerns, higher amounts may. And where more potent chemicals are used, even small amounts in plants could have negative health consequences. Runoff and seepage of those chemicals used in the production of plants and crops also continues to be a problem and raises environmental concerns.

Because of these issues, methods for increasing the production of plants and crops without the use of chemical fertilizers, pesticides and herbicides have been of particular interest and importance. There is also a higher demand for natural or organic products and non-genetically modified plants (such as those that may be genetically modified for use with chemical pesticides). Development of biological agents that have a toxic effect on harmful pests and organisms, but that do not negatively affect the growing crops or plants, and/or that act beneficially as fertilizers or in providing nutrients in promoting the growth of plants with which they are used has increased.

While such biological agents are known, there is a continuing need for the further development of such biological agents.

### SUMMARY

A soil and/or plant amendment composition comprises a base composition. The base composition comprises from 10 wt % to 99.9 wt % aloe vera by total weight of the base composition; from 0.01 wt % to 25 wt % neem by total weight of the base composition; and from 0.01 wt % to 25 wt % turmeric by total weight of the base composition.

In certain embodiments, the aloe vera may be selected from at least one of aloe barbadensis miller, aloe barbadensis chinensis, and aloe indica.

The aloe vera may contain at least one of acemannan, glucose, malic acid, lactic acid, citric acid, and pyruvic acid, as measured from aloe vera powder of the aloe vera using ¹H NMR spectral analysis, in the following amounts: acemannan at from 0.1 wt % to 10 wt % by total weight of aloe vera powder;

glucose at from 0.1 wt % to 10 wt % by total weight of aloe vera powder;

malic acid at from 0.1 wt % to 15 wt % by total weight of aloe vera powder;

lactic acid at from 10 wt % to 20 wt % by total weight of aloe vera powder;

citric acid at from 0.01 wt % to 1.5 wt % by total weight of aloe vera powder; and

pyruvic acid at from 0.01 wt % to 0.1 wt % by total weight of aloe vera powder.

The aloe vera may be derived from whole liquified aloe vera leaf comprising the outer rind, aloe latex, and inner leaf juice. The neem may be derived from neem bark.

In particular applications, the composition may contain from 60 wt % to 90 wt % aloe vera by total weight of the base composition, from 2 wt % to 7 wt % neem by total weight of the base composition, and from 5 wt % to 15 wt % turmeric by total weight of the base composition. The base composition may further contain from 10 wt % to 20 wt % of the at least one of giant kelp and dulse by total weight of the base composition.

The base composition may be in powdered form having a particle size of from 15 μm or less.

The base composition may be mixed with water to form a treatment solution wherein the base composition is used in an amount of from 0.01 wt % to 50 wt % by total weight of the treatment solution. In other instances, the base composition is mixed with water to form a treatment solution, the base composition being used in an amount of from 6 wt % to 20 wt % by total weight of the treatment solution.

The base composition may contain less than 5 wt % by weight of the base composition of any artificial preservatives or chemicals.

In a method of treating plants and/or soil for growing plants a base composition is mixed with water to form a treatment solution. The base composition contains from 10 wt % to 99.9 wt % aloe vera by total weight of the base composition; from 0.01 wt % to 25 wt % neem by total weight of the base composition; and from 0.01 wt % to 25 wt % turmeric by total weight of the base composition. The treatment solution is applied to at least one of the plants and soil.

In particular embodiments, the base composition is used in an amount of from 0.01 wt % to 50 wt % by total weight of the treatment solution.

The base composition may further comprise at least one of giant kelp and dulse in an amount of from 80 wt % or less by total weight of the base composition.

The aloe vera may be selected from at least one of aloe barbadensis miller, aloe barbadensis chinensis, and aloe indica. The aloe vera may contain at least one of acemannan, glucose, malic acid, lactic acid, citric acid, and pyruvic acid, as measured from aloe vera powder of the aloe vera using ¹H NMR spectral analysis, in the following amounts:

acemannan at from 0.1 wt % to 10 wt % by total weight of aloe vera powder;

glucose at from 0.1 wt % to 10 wt % by total weight of aloe vera powder;

malic acid at from 0.1 wt % to 15 wt % by total weight of aloe vera powder;

lactic acid at from 10 wt % to 20 wt % by total weight of aloe vera powder;

citric acid at from 0.01 wt % to 1.5 wt % by total weight of aloe vera powder; and

pyruvic acid at from 0.01 wt % to 0.1 wt % by total weight of aloe vera powder.

The aloe vera may be derived from whole liquified aloe vera leaf comprising the outer rind, aloe latex, and inner leaf juice. The neem may be derived from neem bark.

The base composition may contain from 60 wt % to 90 wt % aloe vera by total weight of the base composition; from 2 wt % to 7 wt % neem by total weight of the base composition or from 3 wt % to 6 wt % neem by total weight of the base composition; and from 5 wt % to 15 wt % turmeric by total weight of the base composition in certain applications. The base composition may also contain from 10 wt % to 20 wt % of the at least one of giant kelp and dulse by total weight of the base composition in certain instances.

The base composition may be in powdered form having a particle size of from 15 μm or less.

The base composition may be used in an amount of from 0.01 wt % to 50 wt % by total weight of the treatment solution.

The treatment solution may be applied to at least one of cereal-grain crops, fruit-bearing plants, vegetable plants, turf, grass, and cannabis. The treatment solution may be applied to the at least one of the plants and soil by spraying, foliar spraying, drip irrigation, direct drenching, aeroponics, and hydroponics. The treatment solution may be applied to serve as at least one of a pesticide, a fertilizer, a biostimulant, a biocide, and a herbicide.

The base composition may contain less than 5 wt % by weight of the base composition of any artificial preservatives or chemicals.

### DETAILED DESCRIPTION

A natural and biological plant and soil amendment composition has been developed that produces healthier and more robust plants and crops without the need for or use of non-natural chemicals, fertilizers and pesticides. The composition is formed from all natural and botanical ingredients, which may be organic, and thus avoids those issues that arise from the use of synthetic chemicals. The composition is formed from a combination of different natural ingredients. These include aloe vera, neem, and turmeric, with or without other natural ingredients.

The plant and soil amendment includes an aloe vera component. Aloe vera provides a variety of benefits to plants. Aloe provides nutrients and acts a food source for plants. It provides vitamins, minerals, enzymes, amino acids, proteins, saccharides, polysaccharides, etc. to the soil and uptake by the plants. Aloe vera also provides growth hormones to plants, such as campestrol, cholesterol, and β-sitosterol. It also acts as an insecticide and a pH adjuster.

The aloe vera used is that derived from the aloe vera leaf. The aloe vera leaf may include the outer rind, aloe latex, and inner leaf juice or gel contained in the leaf. In most applications, the whole leaf of the aloe vera plant or components of all portions (i.e., rind, latex and inner gel) of the whole leaf are used. In particular embodiments, the aloe vera leaves used may be those having a width at their widest point of from 3 inches (7.6 cm) to 5 inches (12.7 cm).

The aloe vera may be one or more of aloe barbadensis, aloe barbadensis miller, aloe barbadensis chinensis, and aloe indica. In many applications, all or a portion of the aloe vera is derived from aloe barbadensis miller. In certain instances, the aloe vera from aloe barbadensis miller may be at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of aloe vera.

It should be noted in the description, if a numerical value, concentration or range is presented, each numerical value should be read once as modified by the term “about” (unless already expressly so modified), and then read again as not so modified unless otherwise indicated in context. Also, in the description, it should be understood that an amount range listed or described as being useful, suitable, or the like, is intended that any and every value within the range, including the end points, is to be considered as having been stated. For example, “a range of from 1 to 10” is to be read as indicating each and every possible number along the continuum between about 1 and about 10.

Thus, even if specific points within the range, or even no point within the range, are explicitly identified or referred to, it is to be understood that the inventor appreciates and understands that any and all points within the range are to be considered to have been specified, and that inventor possesses the entire range and all points within the range.

In some applications, all or a portion of the aloe vera is derived from aloe barbadensis chinensis. Aloe vera from the aloe barbadensis chinensis may be at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of aloe vera.

In still other embodiments, all or a portion of the aloe vera is derived from aloe indica. Aloe vera from the aloe indica may be at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of aloe vera.

Aloe vera is made up of a variety of chemical constituents. These include amino acids, enzymes, minerals, vitamins, lignins, monosaccharides, polysaccharides, salicylic acid, saponins, sterols, and anthraquinones. While none of these may provide very much benefit when used alone, together they act synergistically in products derived from the aloe vera plant in ways that are still not fully understood.

The particular aloe vera used may have different amounts of compounds that differ from other aloe vera. These differences may result from the location and growing conditions and age and/or size of the aloe vera plant. In particular embodiments, the aloe vera leaves will be selected from those that contain particular amounts of acemannan, glucose, malic acid, lactic acid, citric acid, and pyruvic acid.

With respect to the amounts of acemannan, glucose, malic acid, lactic acid, citric acid, and pyruvic acid presented herein, these are determined based upon the analysis of dry whole leaf aloe vera powder derived from the aloe vera leaves using ¹H NMR spectroscopy analysis.

In certain applications, the aloe vera leaves used may be those that contain acemannan in an amount of from 10 wt % or less, more particularly from 5 wt % or less by total weight of the whole leaf aloe vera powder. In some instances, the acemannan present in the aloe vera leaves may be at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, of 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, of 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt %, 6.1 wt %, 6.2 wt %, 6.3 wt %, 6.4 wt %, 6.5 wt %, 6.6 wt %, 6.7 wt %, 6.8 wt %, 6.9 wt %, 7.0 wt %, 7.1 wt %, 7.2 wt %, 7.3 wt %, 7.4 wt %, 7.5 wt %, 7.6 wt %, 7.7 wt %, 7.8 wt %, 7.9 wt %, 8.0 wt %, 8.1 wt %, 8.2 wt %, 8.3 wt %, 8.4 wt %, 8.5 wt %, 8.6 wt %, 8.7 wt %, 8.8 wt %, 8.9 wt %, 9.0 wt %, 9.1 wt %, 9.2 wt %, 9.3 wt %, 9.4 wt %, 9.5 wt %, 9.6 wt %, 9.7 wt %, 9.8 wt %, 9.9 wt %, and 10.0 wt % by total weight of the whole leaf aloe vera powder.

The glucose content of the aloe vera leaves used in some embodiments may be from 10 wt % or less by total weight of the whole leaf aloe vera powder. In some instances, the glucose present in the aloe vera leaves may be at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, of 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, of 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt %, 6.1 wt %, 6.2 wt %, 6.3 wt %, 6.4 wt %, 6.5 wt %, 6.6 wt %, 6.7 wt %, 6.8 wt %, 6.9 wt %, 7.0 wt %, 7.1 wt %, 7.2 wt %, 7.3 wt %, 7.4 wt %, 7.5 wt %, 7.6 wt %, 7.7 wt %, 7.8 wt %, 7.9 wt %, 8.0 wt %, 8.1 wt %, 8.2 wt %, 8.3 wt %, 8.4 wt %, 8.5 wt %, 8.6 wt %, 8.7 wt %, 8.8 wt %, 8.9 wt %, 9.0 wt %, 9.1 wt %, 9.2 wt %, 9.3 wt %, 9.4 wt %, 9.5 wt %, 9.6 wt %, 9.7 wt %, 9.8 wt %, 9.9 wt %, and 10.0 wt % by total weight of the whole leaf aloe vera powder.

In certain applications, the aloe vera leaves used may be those that contain malic acid in an amount of from 15 wt % or less, more particularly from 10 wt % or less by total weight of the whole leaf aloe vera powder, and still more particularly from 5 wt % or less by total weight of the whole leaf aloe vera powder. In some instances, the malic acid present in the aloe vera leaves may be at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, of 1.1 wt %, 1.2 wt %, 1.3 wt %, 1.4 wt %, 1.5 wt %, 1.6 wt %, 1.7 wt %, 1.8 wt %, 1.9 wt %, 2.0 wt %, of 2.1 wt %, 2.2 wt %, 2.3 wt %, 2.4 wt %, 2.5 wt %, 2.6 wt %, 2.7 wt %, 2.8 wt %, 2.9 wt %, 3.0 wt %, 3.1 wt %, 3.2 wt %, 3.3 wt %, 3.4 wt %, 3.5 wt %, 3.6 wt %, 3.7 wt %, 3.8 wt %, 3.9 wt %, 4.0 wt %, 4.1 wt %, 4.2 wt %, 4.3 wt %, 4.4 wt %, 4.5 wt %, 4.6 wt %, 4.7 wt %, 4.8 wt %, 4.9 wt %, 5.0 wt %, 5.1 wt %, 5.2 wt %, 5.3 wt %, 5.4 wt %, 5.5 wt %, 5.6 wt %, 5.7 wt %, 5.8 wt %, 5.9 wt %, 6.0 wt %, 6.1 wt %, 6.2 wt %, 6.3 wt %, 6.4 wt %, 6.5 wt %, 6.6 wt %, 6.7 wt %, 6.8 wt %, 6.9 wt %, 7.0 wt %, 7.1 wt %, 7.2 wt %, 7.3 wt %, 7.4 wt %, 7.5 wt %, 7.6 wt %, 7.7 wt %, 7.8 wt %, 7.9 wt %, 8.0 wt %, 8.1 wt %, 8.2 wt %, 8.3 wt %, 8.4 wt %, 8.5 wt %, 8.6 wt %, 8.7 wt %, 8.8 wt %, 8.9 wt %, 9.0 wt %, 9.1 wt %, 9.2 wt %, 9.3 wt %, 9.4 wt %, 9.5 wt %, 9.6 wt %, 9.7 wt %, 9.8 wt %, 9.9 wt %, 10.0 wt %, 11.0 wt %, of 11.1 wt %, 11.2 wt %, 11.3 wt %, 11.4 wt %, 11.5 wt %, 11.6 wt %, 11.7 wt %, 11.8 wt %, 11.9 wt %, 12.0 wt %, of 12.1 wt %, 12.2 wt %, 12.3 wt %, 12.4 wt %, 12.5 wt %, 12.6 wt %, 12.7 wt %, 12.8 wt %, 12.9 wt %, 13.0 wt %, 13.1 wt %, 13.2 wt %, 13.3 wt %, 13.4 wt %, 13.5 wt %, 13.6 wt %, 13.7 wt %, 13.8 wt %, 13.9 wt %, 14.0 wt %, 14.1 wt %, 14.2 wt %, 14.3 wt %, 14.4 wt %, 14.5 wt %, 14.6 wt %, 14.7 wt %, 14.8 wt %, 14.9 wt %, and 15.0 wt % by total weight of the whole leaf aloe vera powder.

The lactic acid present in the aloe vera leaves used in certain applications may be from 10 wt % to 20 wt % by total weight of the whole leaf aloe vera powder. In some cases, the lactic acid present in the aloe vera leaves may be at least, equal to, and/or between any two of 10.0 wt %, 11.0 wt %, of 11.1 wt %, 11.2 wt %, 11.3 wt %, 11.4 wt %, 11.5 wt %, 11.6 wt %, 11.7 wt %, 11.8 wt %, 11.9 wt %, 12.0 wt %, of 12.1 wt %, 12.2 wt %, 12.3 wt %, 12.4 wt %, 12.5 wt %, 12.6 wt %, 12.7 wt %, 12.8 wt %, 12.9 wt %, 13.0 wt %, 13.1 wt %, 13.2 wt %, 13.3 wt %, 13.4 wt %, 13.5 wt %, 13.6 wt %, 13.7 wt %, 13.8 wt %, 13.9 wt %, 14.0 wt %, 14.1 wt %, 14.2 wt %, 14.3 wt %, 14.4 wt %, 14.5 wt %, 14.6 wt %, 14.7 wt %, 14.8 wt %, 14.9 wt %, 15.0 wt %, 15.1 wt %, 15.2 wt %, 15.3 wt %, 15.4 wt %, 15.5 wt %, 15.6 wt %, 15.7 wt %, 15.8 wt %, 15.9 wt %, 16.0 wt %, 16.1 wt %, 16.2 wt %, 16.3 wt %, 16.4 wt %, 16.5 wt %, 16.6 wt %, 16.7 wt %, 16.8 wt %, 16.9 wt %, 17.0 wt %, 17.1 wt %, 17.2 wt %, 17.3 wt %, 17.4 wt %, 17.5 wt %, 17.6 wt %, 17.7 wt %, 17.8 wt %, 17.9 wt %, 18.0 wt %, 18.1 wt %, 18.2 wt %, 18.3 wt %, 18.4 wt %, 18.5 wt %, 18.6 wt %, 18.7 wt %, 18.8 wt %, 18.9 wt %, 19.0 wt %, 19.1 wt %, 19.2 wt %, 19.3 wt %, 19.4 wt %, 19.5 wt %, 19.6 wt %, 19.7 wt %, 19.8 wt %, 19.9 wt %, and 20.0 wt % by total weight of the whole leaf aloe vera powder.

In some embodiments, the aloe vera leaves used may be those that contain citric acid in an amount of from 1.50 wt % or less by total weight of the whole leaf aloe vera powder. In certain instances, the citric acid present in the aloe vera leaves may be at least, equal to, and/or between any two of 0.01 wt %, 0.02 wt %, 0.03 wt %, 0.04 wt %, 0.05 wt %, 0.06 wt %, 0.07 wt %, 0.08 wt %, 0.09 wt %, 0.10 wt %, 0.11 wt %, 0.12 wt %, 0.13 wt %, 0.14 wt %, 0.15 wt %, 0.16 wt %, 0.17 wt %, 0.18 wt %, 0.19 wt %, 0.20 wt %, 0.21 wt %, 0.22 wt %, 0.23 wt %, 0.24 wt %, 0.25 wt %, 0.26 wt %, 0.27 wt %, 0.28 wt %, 0.29 wt %, 0.30 wt %, 0.31 wt %, 0.32 wt %, 0.33 wt %, 0.34 wt %, 0.35 wt %, 0.36 wt %, 0.37 wt %, 0.38 wt %, 0.39 wt %, 0.40 wt %, 0.41 wt %, 0.42 wt %, 0.43 wt %, 0.44 wt %, 0.45 wt %, 0.46 wt %, 0.47 wt %, 0.48 wt %, 0.49 wt %, 0.50 wt %, 0.51 wt %, 0.52 wt %, 0.53 wt %, 0.54 wt %, 0.55 wt %, 0.56 wt %, 0.57 wt %, 0.58 wt %, 0.59 wt %, 0.60 wt %, 0.61 wt %, 0.62 wt %, 0.63 wt %, 0.64 wt %, 0.65 wt %, 0.66 wt %, 0.67 wt %, 0.68 wt %, 0.69 wt %, 0.70 wt %, 0.71 wt %, 0.72 wt %, 0.73 wt %, 0.74 wt %, 0.75 wt %, 0.76 wt %, 0.77 wt %, 0.78 wt %, 0.79 wt %, 0.80 wt %, 0.81 wt %, 0.82 wt %, 0.83 wt %, 0.84 wt %, 0.85 wt %, 0.86 wt %, 0.87 wt %, 0.88 wt %, 0.89 wt %, 0.90 wt %, 0.91 wt %, 0.92 wt %, 0.93 wt %, 0.94 wt %, 0.95 wt %, 0.96 wt %, 0.97 wt %, 0.98 wt %, 0.99 wt %, 1.00 wt %, 1.01 wt %, of 1.01 wt %, 1.02 wt %, 1.03 wt %, 1.04 wt %, 1.05 wt %, 1.06 wt %, 1.07 wt %, 1.08 wt %, 1.09 wt %, 1.10 wt %, of 1.11 wt %, 1.12 wt %, 1.13 wt %, 1.14 wt %, 1.15 wt %, 1.16 wt %, 1.17 wt %, 1.18 wt %, 1.19 wt %, 1.20 wt %, of 1.21 wt %, 1.22 wt %, 1.23 wt %, 1.24 wt %, 1.25 wt %, 1.26 wt %, 1.27 wt %, 1.28 wt %, 1.29 wt %, 1.30 wt %, of 1.31 wt %, 1.32 wt %, 1.33 wt %, 1.34 wt %, 1.35 wt %, 1.36 wt %, 1.37 wt %, 1.38 wt %, 1.39 wt %, 1.40 wt %, of 1.41 wt %, 1.42 wt %, 1.43 wt %, 1.44 wt %, 1.45 wt %, 1.46 wt %, 1.47 wt %, 1.48 wt %, 1.49 wt %, and 1.50 wt % by total weight of the whole leaf aloe vera powder.

The pyruvic acid present in the aloe vera leaves used in certain applications may be from 0.10 wt % or less by total weight of the whole leaf aloe vera powder. In some cases, the pyruvic acid present in the aloe vera leaves may be at least, equal to, and/or between any two of 0.01 wt %, 0.02 wt %, 0.03 wt %, 0.04 wt %, 0.05 wt %, 0.06 wt %, 0.07 wt %, 0.08 wt %, 0.09 wt %, and 0.10 wt % by total weight of the whole leaf aloe vera powder.

In certain embodiments, the aloe vera may be “green” aloe vera that has not been treated or processed to remove any compounds. In other embodiments, the aloe vera may be “white” aloe vera wherein it is treated, such as through extraction filtration, to remove certain compounds. In particular, this may include the removal or reduction in content of one or more or all of the anthraquinones (e.g., aloin A, aloin B, aloe-emodin, etc.) that may be present in the aloe vera leaf.

The plant and soil amendment further includes a neem component. Neem has antifungal and insecticidal properties that make it useful as a plant and soil amendment. Neem or azadirachta indica is derived from neem trees that are chiefly grown in tropical and subtropical climates. Neem acts as an insecticide, repelling and disrupting the growth and reproduction of insects. Neem compounds can be extracted from different parts of the neem tree plant. In particular, neem can be extracted from the bark, twigs, leaves, flowers, seeds, and fruit pulp of the neem tree. The neem may be in a powdered form wherein the various constituents of the neem tree are dried and then ground into a powder. The neem will typically have a particle size of from 10 μm or more and may need to be reduced in forming the final base composition, as is discussed later on. Alternatively, the neem may be in the form of neem oil that is extracted from the solid neem constituents, such as through pressing or through solvent extraction.

In particular embodiments, the neem component is that derived from the bark of the neem tree. Neem derived from the flowers and leaves has been shown to be less effective in the compositions described herein. In particular embodiments, from greater than 50 wt % or more of the neem used is derived from neem bark, with any remaining neem being derived from one or more of the leaves, flowers, seeds, and fruit pulp of the neem tree. In certain instances, the neem content from neem bark may be from at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of neem.

Neem derived from the flower may be slightly less effective than neem derived from bark. Neem derived from the flower, however, may still be used. In such cases, the neem content from neem flowers may be from at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of neem, with neem derived from neem flowers typically being used in amounts of from 50 wt % or less or less than 50 wt % or less by total weight of neem.

Neem derived from the neem leaves may be still less effective from neem derived from the flowers and/or bark. Neem derived from the leaves, however, may still be used. In such cases, the neem content from neem leaves may be from at least, equal to, and/or between any two of 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, and 100 wt % by total weight of neem, with neem derived from neem leaves typically being used in amounts of from 50 wt % or less or less than 50 wt % or less by total weight of neem.

A turmeric component is also a part of the plant and soil amendment. Turmeric acts as a natural insecticide, which is useful against a variety of different insects, such as aphids, mites, ants, larvae, etc. Turmeric or curcuma longa is derived from turmeric plants that are chiefly grown in tropical and subtropical climates. The turmeric is typically derived from the rhizomes or rootstalks of the turmeric plant. After harvesting, the turmeric rhizomes are boiled in water or an alkaline aqueous solution to cure and soften the rhizome. The rhizomes may then sliced to facilitate drying and dried at temperatures of from 60° C. or less so that the dried turmeric has a moisture content of from 5 wt % to 10 wt %. Thereafter, the dried rhizomes can be crushed or ground into a powder. The turmeric may have a particle size of from 10 um or more and may need to be reduced in forming the final base composition, as is discussed later on

As a further optional component, seaweed can also be used in the soil and plant amendment composition. The seaweed component can be comprised of macrocystis pyrifera, often referred to as giant kelp or giant bladder kelp, and/or palmaria palmata, often referred to as dulse. These are aquatic plants that typically grow in the northern Atlantic and Pacific oceans. Those plants grown around the coasts of Iceland have been found to be particularly useful for use in the composition. Such seaweed from colder waters tends to be much more nutrient dense than that which grows in warmer locations. The giant kelp and dulse may be used together as a mixture in proportions of each ranging from greater than zero to less than 100 wt %. In other instances, the giant kelp or dulse may be used separately (i.e., 100 wt %) as the seaweed component.

The seaweed component constitutes an agricultural biostimulant that provides a variety of different beneficial properties for use in the plant and soil amendment. These include increasing of crop yields by increasing the efficiency of the plant's metabolism, as well as improving plant and crop quality. Increased plant tolerance and recovery to abiotic stress, i.e., non-living disturbances, such as excessive sunlight, temperatures, moisture, etc., is also achieved through their use. The seaweed also adds nutrients to the soil (e.g., nitrogen, potassium, calcium, etc.) and increases nutrient uptake, improvement of water usage, and the enhancement of soil fertility by developing complimentary soil microorganisms.

The seaweed is typically washed and dried and then chopped, ground, crushed, or otherwise pulverized to form a powder. The seaweed may have a particle size of from 10 μm or more and may need to be reduced in forming the final base composition, as is discussed later on.

Each of the above-described components are combined to form a base composition for use as a plant and soil amendment. The base composition may contain the aloe component in an amount of from 10 wt % to 99.9% aloe vera by total weight of the base composition. In particular embodiments, the aloe vera component may range from 60 wt % to 90 wt % aloe vera by total weight of the base composition. In certain instances the aloe vera component may be from at least, equal to, and/or between any two of 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt %, 99.1 wt %, 99.2 wt %, 99.3 wt %, 99.4 wt %, 99.5 wt %, 99.6 wt %, 99.7 wt %, 99.8 wt %, and 99.9 wt % aloe vera by total weight of the base composition.

The base composition may contain the neem component in an amount of from 0.01 wt % to 25 wt % neem by total weight of the base composition. In particular embodiments, the neem component may range from 2 wt % to 7 wt % neem by total weight of the base composition, and still more particular from 3 wt % to 6 wt % by total weight of the base composition. In certain instances the neem component may be from at least, equal to, and/or between any two of 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 25 wt % neem by total weight of the base composition.

The turmeric component of the base composition may be present in an amount of from 0.01 wt % to 25 wt % turmeric by total weight of the base composition. In particular embodiments, the turmeric component may range from 5 wt % to 15 wt % turmeric by total weight of the base composition. In certain instances the turmeric component may be from at least, equal to, and/or between any two of 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 25 wt % turmeric by total weight of the base composition.

If used, the seaweed component of the giant kelp and/or dulse may be present in the base composition in an amount of from 80 wt % or less by total weight of the base composition. In particular embodiments, the seaweed component may range from 10 wt % to 20 wt % of the giant kelp and/or dulse by total weight of the base composition. In certain instances the giant kelp/dulse component may be from at least, equal to, and/or between any two of 0 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, and 80 wt % giant kelp and/or dulse by total weight of the base composition.

In particular embodiments, the aloe vera, neem, turmeric, and optional seaweed component are the only components making up the soil and plant amendment base composition. In some cases other ingredients may be used or be present. Any one or all of such additional materials may be present in an amount of from 10 wt %, 5 wt %, 1 wt %, 0.01 wt %, 0.005 wt %, or 0.001 wt % or less by total weight of the base composition. No artificial preservatives or chemicals may be used in the final base composition. If such artificial preservatives or chemicals are used (e.g., potassium sorbate, sodium citrate, etc.), however, these may be present in an amount of from 5 wt %, 4 wt %, 3 wt %, 2 wt %, 1 wt %, 0.5 wt %, 0.01 wt %, 0.005 wt %, 0.001 wt % or less by total weight of the base composition.

In forming the base composition, the whole aloe vera leaves used are typically processed to preserve their desired properties and to prevent their degradation. This may include processing the aloe vera leaves within a few days from harvesting. This may be with 14 days or less or within 1 day, 2 days, 3 days, 4 days, 5 days, 6 days, 7 days, 8 days, 9 days, 10 days, 11 days, 12 days, 13 days, or 14 days from harvesting. Typically, the harvested aloe vera may be cooled soon after harvesting or else be processed immediately after harvesting (e.g., 6 hours or less). This may include immediately loading the harvested aloe vera in refrigerated storage facilities or transport vehicles used to transport the harvested aloe to a refrigerated storage facility. The harvested aloe vera leaves may be cooled to a temperature of from 34° F. to 42° F. (1.1° C. to 5.6° C.) and stored at such temperatures for all or a major portion of time subsequent to harvesting and up until the aloe vera is processed. If not cooled prior to processing, the aloe vera may go directly to processing, such as in a processing facility located near the harvest area within 24 hours from harvesting. Such cooling and/or quick processing reduces the respiration rate of the harvested aloe vera and reduces the natural enzymes that are released, and which can degrade the aloe vera.

In processing the aloe vera, the aloe vera leaves are washed and then liquified.

Processing may also be conducted under reduced temperatures, as well. Such processing may take place at temperatures of from 34° F. to 42° F. (1.1° C. to 5.6° C.). In most embodiments, the processing includes liquification of the whole aloe vera leaves, which includes the outer rind, aloe latex, and inner leaf gel contained in the leaf. Less or more than the entire outer rind and/or aloe latex of the aloe vera leaves may be used, such as where a portion of the outer rind and/or aloe latex has been previously removed from the aloe vera leaves or where an amount of removed outer rind and/or aloe latex has been previously removed from the aloe vera leaves. This may then be added to other whole aloe vera leaves in forming the liquefied aloe vera. In such cases, the outer rind and/or aloe latex of the aloe vera used may range from 50 wt % to 150 wt % of the outer rind and/or aloe latex that would be normally present had these components not been removed or added to the whole aloe vera leaves processed.

Liquification may be carried out at or below room temperature (i.e., 25° C. or less) in a high-speed industrial juicer or liquefier that operates at high rpm and high efficiency. In certain instances, the liquification may occur at reduced temperatures, such as from 34° F. to 42° F. (1.1° C. to 5.6° C.). The liquification should be carried out a high enough rate so that the aloe vera is liquefied within a few minutes (e.g., 25 minutes or less) to reduce enzymatic activity and degradation of the aloe vera. The liquification should be sufficient so that there are no aloe vera solids that need to be separated from the liquefied aloe vera juice. The final liquid viscosity of the aloe vera juice may range from 1200 cP to 2000 cP at 25° C. using a Brookfield viscometer with a No. 6 spindle. The liquified aloe vera may then be filtered to remove non-aloe-vera contaminants (e.g., soil particles, etc.).

If desired, the liquified and filtered aloe vera may be further treated to remove the anthraquinone components. This may be through diatomaceous earth filtration. The liquefied aloe vera juice may also be used as is without removal of any aloe vera constituents or anthraquinone components.

The liquified aloe vera juice may be dried, such as through spray drying, to form a dry powder of the whole aloe vera leaves. In some instances, spray drying temperatures may range from 300° F. to 350° F. (148.9° C. to 176.7° C.). The dried aloe vera juice may then be pulverized, if necessary, into a powder. The dried aloe vera powder may then be reconstituted with water to reform the aloe vera juice. In powdered form, the dried aloe vera may have a particle size of less than 15 microns.

In most applications, the other ingredients of neem, turmeric, and any optional seaweed components, may be combined by directly admixing them to the aloe vera juice, which may be newly formed directly from the aloe leaves or reconstituted, to form the base composition mixture. The base mixture may then be pasteurized to kill bacteria that may be present in the mixture.

After heating, the base mixture is dried, such as through spray drying. The drying may be conducted at cooled or refrigerated temperatures of from 0° F. to 42° F. (−17. 8° C. to 5.6° C.). The dried base composition material may then be crushed, ground, milled, or otherwise pulverized to form a powder. This may also be conducted at cool temperatures such as from 34° F. to 42° F. (1.1° C. to 5.6° C.). The final base composition will typically be a powder having a particle size of from 15 μm or less. In certain applications, the base composition will be in a powder form having a particle size of from 1 μm to 15 μm, more particularly from 5 μm to 10 μm. In certain instances, the final base composition will be in a powder form having a particle size that may be from at least, equal to, and/or between any two of 1 μm, 2 μm, 3 μm, 4 μm, 5 μm, 6 μm, 7 μm, 8 μm, 9 μm, 10 μm, 11 μm, 12 μm, 13 μm, 14 μm, and 15 μm.

The powdered base composition may be packaged in containers for transport and storage to be used at a later time and/or location.

When ready for use, the base composition is admixed with fresh water or an aqueous fresh-water liquid component to form a liquid soil and/or plant amendment treatment composition. The small particle sizes of the base composition facilitate keeping the particles in suspension so that they do not readily settle out of the treatment solution. It should be noted that although reference may be made to a “treatment solution,” such expression or similar expressions is used for convenience and does not necessarily mean that the base composition and/or its constituents are dissolved in the liquid but may only be held in suspension. Some constituents of the base composition may be truly dissolved in the treatment solution, however.

The base composition is typically used in an amount of from 0.01 wt % to 50 wt % by total weight of the liquid treatment solution. In particular embodiments, the base composition is used in an amount of from 5 wt % to 20 wt % by total weight of the treatment solution. In certain instances, the base composition may be used in the treatment composition in an amount that may be from at least, equal to, and/or between any two of 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, and 50 wt % by total weight of the treatment solution.

The final amount of aloe vera component in the final treatment solution may range from 1 wt % to 49.95 wt % to total weight of the treatment solution. In particular embodiments, the amount of aloe vera component in the treatment solution may be from at least, equal to, and/or between any two of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt %, 41 wt %, 42 wt %, 43 wt %, 44 wt %, 45 wt %, 46 wt %, 47 wt %, 48 wt %, 49 wt %, and 49.95 wt % by total weight of the treatment solution.

The final amount of neem component in the final treatment solution may range from 0.001 wt % to 12.5 wt % to total weight of the treatment solution. In particular embodiments, the amount of neem component in the treatment solution may be from at least, equal to, and/or between any two of 0.001 wt %, 0.002 wt %, 0.003 wt %, 0.004 wt %, 0.005 wt %, 0.006 wt %, 0.007 wt %, 0.008 wt %, 0.009 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 12.1 wt %, 12.2 wt %, 12.3 wt %, 12.4 wt %, and 12.5 wt % by total weight of the treatment solution.

The final amount of turmeric component in the final treatment solution may range from 0.001 wt % to 12.5 wt % to total weight of the treatment solution. In particular embodiments, the amount of turmeric in the treatment solution may be from at least, equal to, and/or between any two of 0.001 wt %, 0.002 wt %, 0.003 wt %, 0.004 wt %, 0.005 wt %, 0.006 wt %, 0.007 wt %, 0.008 wt %, 0.009 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 12.1 wt %, 12.2 wt %, 12.3 wt %, 12.4 wt %, and 12.5 wt % by total weight of the treatment solution.

If used, the seaweed component of the giant kelp and/or dulse may be present in the final treatment solution may range from 0.001 wt % to 40 wt % to total weight of the treatment. In particular embodiments, the amount of giant kelp and/or dulse in the treatment solution may be from at least, equal to, and/or between any two of 0.001 wt %, 0.002 wt %, 0.003 wt %, 0.004 wt %, 0.005 wt %, 0.006 wt %, 0.007 wt %, 0.008 wt %, 0.009 wt %, 0.01 wt %, 0.02 wt %, 0.03 wt %, 0.04 wt %, 0.05 wt %, 0.06 wt %, 0.07 wt %, 0.08 wt %, 0.09 wt %, 0.1 wt %, 0.2 wt %, 0.3 wt %, 0.4 wt %, 0.5 wt %, 0.6 wt %, 0.7 wt %, 0.8 wt %, 0.9 wt %, 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, and 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, and 40 wt % by total weight of the treatment solution.

The amount of base composition used in the treatment solution may vary depending upon the application, geographic area, soil type, plant type, etc.

The treatment solution can be used in a variety of different ways. It can be used as a soil amendment (i.e., only applied to the soil and not the plants) or a plant amendment where it may be applied to the plants themselves. The treatment solution can be applied to the soil, used to soak seed during germination, in drip irrigation, in flood drenching, in hydroponics, in aeroponics, and the like.

In hydroponics plants are grown without soil, although they may be supported in an inert aggregate medium, such as gravel. In hydroponic applications, the treatment solution may be circulated as a liquid at selected times to nourish the roots of the plants grown in these environments.

In aeroponics, the plants are supported without the use of soil or aggregate.

At selected times, the plants are subjected to a mist of the treatment solution. For example, every few seconds the plants may subjected to a dose of treatment solution mist. This can also be done on a large scale operation, with the plants covering a vertical wall or walls of a building.

In spray applications, the base composition described herein can be added to water to form a treatment solution. The treatment solution can then be applied as a spray to the plants once the plants are at a juvenile stage, typically defined as the point where the emerging plants have from 2 to 4 or more leaves. This spray application may also be used to maintain growing crops or plants, with the spray applied directly to the plants or crops.

Depending on the application, different sized spray nozzles may be used to achieve desired spray rates of the treatment solution. The treatment solution may be selectively reapplied (e.g., every 7 to 10 days) to facilitate plant growth. Outdoor spray applications may be conducted during the evenings.

In another application, seeds are soaked in a treatment solution during seed germination. In such applications, a substrate material is soaked in the treatment solution composition with the seeds being placed in contact with the substrate material and left until the seeds germinate. In another application, the treatment solution and seeds are placed in a plastic bag or other container and left alone until the seeds germinate.

In still yet another application, either shortly before or after seeds are planted in the soil, the soil may be flooded with the treatment solution. This is also known as a drenching method and is beneficial to the soil with the base composition and treatment solution acting as a soil amendment.

The compositions described herein can be used for a variety of plants and crops. They can be used for cultivating and growing cereal grain crops, such a wheat, barley, corn, millet, sorghum, rice, oats, etc. Other crops, such as various fruits and vegetables can benefit from the use of the treatment compositions. The compositions can also be used in growing turfs and grasses. The treatment compositions may also be particularly useful in the growing of cannabis plants and hemp. Other plants can also benefit from the use of the treatment compositions described herein.

The following examples serve to further illustrate various embodiments and applications.

EXAMPLES

### Example 1

### ¹H NMR Testing of Whole Leaf Aloe Vera Powder

The following testing method was used to test for different compounds of whole aloe vera leaf powder.

A reference of nicotinic acid amide (nicotinamide) 99.5+%, from Sigma-Aldrich was used. Chemicals used in the study: deuterium oxide (99.8%D), 20% DC1 in D₂O (99.8%D), 98% D₂SO₄ in D₂O—Cambridge Isotope Laboratories, Andover, Mass., (NMR Solvents).

Using a Mercury 300 NMR spectrometer operating at 7.05T (˜299.94 MHz), and a Varian 5 mm Switchable broad-band probe, a ¹H NMR spectrum was acquired at a spectrometer frequency of 299.94 MHz. A spectral window of 7.2 kHz was acquired with a 60° pulse angle, a 4 sec relaxation delay and an acquisition time of 4.448 sec collecting 32K data points. 64 transients were collected on the sample with solvent suppression. 64 transients were collected on the sample after acidification with DC1 allowing quantitation of isocitrate.

The sample was also analyzed after full hydrolyzation using 98% D2504 at 98° C. for 2 hours. A measured amount of sample (˜20 mg) was added to 0.75 ml of D₂O along with a measured amount of the standard material (nicotinic acid amide) (approx.

10-20 mg). Actual weights for the nicotinamide standard was 15.3 mg and the aloe powder sample was 30.5 mg.

Molar ratios of individual components were calculated against the molar intensity of an accurately weighed standard (nicotinamide). From the molar intensities the wt % of each component was calculated. The following components by weight percentage of the powder were obtained and are presented in Table 1 below.

TABLE 1
Whole Leaf Aloe Vera Powder

| Component | Wt % |
|---|---|
| Acemannan | 2.78 |
| Glucose | 7.85 |
| Malic Acid | 1.16 |
| Lactic Acid | 16.98 |
| Citric Acid | 0.06 |
| Pyruvic Acid | 0.00 |
| Sorbate | 0.00 |
| Benzoate | 0.00 |
| Acetoin | 0.00 |
| 2,3-butandiol | 0.00 |
| Isocitrate | 11.33 |
| Isocitrate Lactone | 4.29 |
| Acetic Acid | 0.56 |
| Succinic Acid | 0.69 |
| Formic Acid | 0.00 |
| Fumaric Acid | 0.00 |
| Ethanol | 0.00 |
| Glycine | 0.00 |
| Propylene Glycol | 0.00 |
| Maltodextrin | 0.00 |
| Sucrose | 26.64 |

### Example 2

To test the effectiveness of the soil and plant amendment composition, an exemplary formulation was used against the fungal plant Elsinoe australis, also known as sweet orange scab (SOS). Fruits of grapefruit and sweet oranges with symptoms of SOS were collected from a small grove and were sorted at random into groups before application of treatments. In all experiments, fruits were washed for 2 minutes in tap water before treatment with the treatment composition.

Various treatment solutions were provided using different amounts of base composition in fresh water. The base composition contained 85 wt % of aloe vera (aloe barbadensis miller), 5 wt % of neem, and 10 wt. % of turmeric. The aloe vera of the base composition was that derived from liquified whole leaf aloe vera juice without the removal of any constituents. The neem was that derived from neem bark. The base composition had a particle size of 10 μm or less.

The treatment was carried out by submerging the fruits into the treatment solution for 2-3 minutes. To facilitate the isolation of the pathogen, all treated fruits including the controls were dried under a laminar air flow for three days. Isolation of E. australis from each fruit was made by scraping the fruit with a steel brush to remove minute pieces of the rind tissue. This was added to culture plates containing a mixture of malt yeast agar (MYA), potato dextrose agar (PDA) or rose bengal agar (RB). All isolation media were amended with Dodine (400 ppm), Streptomycin (100 ppm) and Tetracycline (100 ppm). The culture plates were incubated at 26° C. and the presence or absence of colonies of E. australis was recorded after 12 or 15 days of incubation. The amount of the base composition used in each experiment and the number of fruits tested are listed in Table 2 below.

TABLE 2

| | Base | | Number | |
|---|---|---|---|---|
| | Composition | | of Fruits | Fruits with E. |
| Sample | (wt %) | Host | Tested | australis (%) |
| Comparative 1 | 0 | Grapefruit | 30 | 44.4 |
| 2 | 2.5 | Grapefruit | 30 | 38.9 |
| 3 | 8 | Grapefruit | 30 | 15.6 |
| Comparative 4 | 0 | Grapefruit | 360 | 44.2 |
| 5 | 10 | Grapefruit | 360 | 35.3 |
| 6 | 12 | Grapefruit | 360 | 34.7 |
| Comparative 7 | 0 | Orange | 90 | 45.6 |
| 8 | 8 | Orange | 90 | 28.9 |

As shown in Table 2 above, the effect of the treatment solution on the recovery of E. australis colonies from grapefruits and oranges was significant. Comparative Samples 1, 4, and 7 without any treatment with the treatment composition had similar amounts of E. australis colonies. Those treated with treatment solutions containing from 2.5 wt % or more (Samples 2-3, 5-6, and 8) of the base treatment composition had significantly lower amounts of E. australis colonies.

While the invention has been shown in only some of its forms, it should be apparent to those skilled in the art that it is not so limited, but is susceptible to various changes and modifications without departing from the scope of the invention. Accordingly, it is appropriate that the appended claims be construed broadly and in a manner consistent with the scope of the invention.

I claim:

1. A soil and/or plant amendment composition comprising:
a base composition comprising:
from 10 wt % to 99.9 wt % aloe vera by total weight of the base composition;
from 0.01 wt % to 25 wt % neem by total weight of the base composition; and
from 0.01 wt % to 25 wt % turmeric by total weight of the base composition.

2. The composition of claim 1, further comprising:
at least one of giant kelp and dulse in an amount of from 80 wt % or less by total weight of the base composition.

3. The composition of claim 1, wherein:
the aloe vera is selected from at least one of aloe barbadensis miller, aloe barbadensis chinensis, and aloe indica.

4. The composition of claim 1, wherein:
the aloe vera contains at least one of acemannan, glucose, malic acid, lactic acid, citric acid, and pyruvic acid, as measured from aloe vera powder of the aloe vera using ¹H NMR spectral analysis, in the following amounts:
acemannan at from 0.1 wt % to 10 wt % by total weight of aloe vera powder;
glucose at from 0.1 wt % to 10 wt % by total weight of aloe vera powder;
malic acid at from 0.1 wt % to 15 wt % by total weight of aloe vera powder;
lactic acid at from 10 wt % to 20 wt % by total weight of aloe vera powder;
citric acid at from 0.01 wt % to 1.5 wt % by total weight of aloe vera powder; and
pyruvic acid at from 0.01 wt % to 0.1 wt % by total weight of aloe vera powder.

5. The composition of claim 1, wherein:
the aloe vera is derived from whole liquified aloe vera leaf comprising the outer rind, aloe latex, and inner leaf juice.

6. The composition of claim 1, wherein:
the neem is derived from neem bark.

7. The composition of claim 1, wherein:
the composition contains from 60 wt % to 90 wt % aloe vera by total weight of the base composition.

8. The composition of claim 1, wherein:
the base composition contains from 2 wt % to 7 wt % neem by total weight of the base composition.

9. The composition of claim 1, wherein:
the base composition contains from 5 wt % to 15 wt % turmeric by total weight of the base composition.

10. The composition of claim 2, wherein:
the base composition contains from 10 wt % to 20 wt % of the at least one of giant kelp and dulse by total weight of the base composition.

11. The composition of claim 1, wherein:
the base composition is in powdered form having a particle size of from 15 μm or less.

12. The composition of claim 1, wherein:
the base composition is mixed with water to form a treatment solution wherein the base composition is used in an amount of from 0.01 wt % to 50 wt % by total weight of the treatment solution.

13. The composition of claim 1, wherein:
the base composition is mixed with water to form a treatment solution, the base composition being used in an amount of from 6 wt % to 20 wt % by total weight of the treatment solution.

14. The composition of claim 1, wherein:
the base composition contains less than 5 wt % by weight of the base composition of any artificial preservatives or chemicals.

15. A method of treating plants and/or soil for growing plants comprising:
mixing a base composition with water to form a treatment solution, wherein the base composition comprises:
from 10 wt % to 99.9 wt % aloe vera by total weight of the base composition;
from 0.01 wt % to 25 wt % neem by total weight of the base composition; and
from 0.01 wt % to 25 wt % turmeric by total weight of the base composition; and
applying the treatment solution to at least one of the plants and soil.

16. The method of claim 15, wherein:
the base composition is used in an amount of from 0.01 wt % to 50 wt % by total weight of the treatment solution.

17. The method of claim 15, wherein:
the base composition further comprises at least one of giant kelp and dulse in an amount of from 80 wt % or less by total weight of the base composition.

18. The method of claim 15, wherein:
the aloe vera is selected from at least one of aloe barbadensis miller, aloe barbadensis chinensis, and aloe indica.

19. The method of claim 15, wherein:
the aloe vera contains at least one of acemannan, glucose, malic acid, lactic acid, citric acid, and pyruvic acid, as measured from aloe vera powder of the aloe vera using ¹H NMR spectral analysis, in the following amounts:
acemannan at from 0.1 wt % to 10 wt % by total weight of aloe vera powder;
glucose at from 0.1 wt % to 10 wt % by total weight of aloe vera powder;
malic acid at from 0.1 wt % to 15 wt % by total weight of aloe vera powder;
lactic acid at from 10 wt % to 20 wt % by total weight of aloe vera powder;
citric acid at from 0.01 wt % to 1.5 wt % by total weight of aloe vera powder; and
pyruvic acid at from 0.01 wt % to 0.1 wt % by total weight of aloe vera powder.

20. The method of claim 15, wherein:
the aloe vera is derived from whole liquified aloe vera leaf comprising the outer rind, aloe latex, and inner leaf juice.

21. The method of claim 15, wherein:
the neem is derived from neem bark.

22. The method of claim 15, wherein:
the base composition contains from 60 wt % to 90 wt % aloe vera by total weight of the base composition.

23. The method of claim 15, wherein:
the composition contains from 2 wt % to 7 wt % neem by total weight of the base composition.

24. The method of claim 15, wherein:
the base composition contains from 3 wt % to 6 wt % neem by total weight of the base composition.

25. The method of claim 15, wherein:
the base composition contains from 5 wt % to 15 wt % turmeric by total weight of the base composition.

26. The method of claim 17, wherein:
the base composition contains from 10 wt % to 20 wt % of the at least one of giant kelp and dulse by total weight of the base composition.

27. The method of claim 15, wherein:
the base composition is in powdered form having a particle size of from 15 um or less.

28. The method of claim 15, wherein:
wherein the base composition is used in an amount of from 0.01 wt % to 50 wt % by total weight of the treatment solution.

29. The method of claim 15, wherein:
the treatment solution is applied to at least one of cereal-grain crops, fruit-bearing plants, vegetable plants, turf, grass, and cannabis.

30. The method of claim 15, wherein:
the treatment solution is applied to the at least one of the plants and soil by spraying, foliar spraying, drip irrigation, direct drenching, aeroponics, and hydroponics.

31. The method of claim 15, wherein:
the base composition contains less than 5 wt % by weight of the base composition of any artificial preservatives or chemicals.

32. The method of claim 15, wherein:
the treatment solution is applied to serve as at least one of a pesticide, a fertilizer, a biostimulant, a biocide, and a herbicide.
